(19) United States
(12) Patent Application Publication
(10) Pub. No.: US 2026/0134469 A1
(43) Pub. Date: May 14, 2026

(54) REAL TIME EVENT NOTIFICATION

(71) Applicant: FMR LLC, Boston, MA (US)

(72) Inventors: Lee Gondorchin, Spring, TX (US); Sujith Kumar T L, Karnataka (IN); Theodore Nienstedt, Raleigh, NC (US); Firas Khasawneh, Raleigh, NC (US); Michael Helms, Jenison, MI (US); Bude Saheb Shaik, Cary, NC (US); Gregory Wayne Harvey, McKinney, TX (US)

(21) Appl. No.: 19/381,946

(22) Filed: Nov. 6, 2025

Related U.S. Application Data
(60) Provisional application No. 63/718,173, filed on Nov. 8, 2024.

(51) Int. Cl. G06Q 40/02; G06F 9/54; G06N 20/00; G06Q 40/06

(52) U.S. Cl. CPC G06Q 40/0222; G06F 9/542; G06N 20/00; G06Q 40/026; G06Q 40/06

(57) ABSTRACT

A computerized method is provided for real-time aggregation, curation, enrichment, and streaming of event-based notifications from various back-end systems to client user devices or web sessions via a persistent, stateful connection.

### CROSS-REFERENCE TO RELATED APPLICATIONS

This application claims the benefit of and priority to U.S. Provisional Application Ser. No. 63/718,173, filed Nov. 8, 2024, the content of which is incorporated herein by reference in its entirety.

### TECHNICAL FIELD

This application relates generally to systems, methods, and apparatuses, including computer program products, for real time events streaming with artificial intelligence guidance.

### BACKGROUND

Individuals are exposed to ever increasing amounts of data today. Many Americans spend much of their day on an internet-connected computer and carry a smart phone with constant connectivity, even when away from their desks. Through websites and an increasing number of smart phone apps, users are inundated with unending notifications including general and/or personalized news, weather, sports information, messaging, social media posts, financial information, and more. Customers, especially in the financial services industry, may derive a perceived edge in real time monitoring of markets and their own personal finances.

Customers have shown an appetite and expectation for real-time notifications that have accordingly increased in type and volume. The scope of financial information includes both public and private channels, to which customers may want to subscribe. Examples of the former include general announcements, monitoring markets (DJIA, NASDAQ, S&P 500, Bitcoin); examples of the latter include monitoring personal interests like spending, investment portfolios, budgeting, and credit ratings.

While customer appetite for notifications remains strong, with the increasing flow of information, there is a risk that appetite will wane, and frustration will result. Notification volume has the potential to grow too high while quality or usefulness of the delivered information may decline. Frustrated customers may become disengaged or even resentful toward the organizations that are flooding their devices with unwanted notifications.

Today's digital experience front-end applications and supporting back-end systems need significant improvements to support emerging needs of real-time notifications. In some cases, customers get too many notifications causing, for example, desensitization to future notification such that the future notification are ignored. In other cases customers can get erroneous notifications based on pending account changes or additions, thereby causing customers to lose confidence in the notification system. Developer experience is also a concern because there is a lack of agreement, understanding, and, therefore, common approaches along with common components to provide consistent, reliable and secure real-time notifications.

### SUMMARY

Systems and methods of the invention provide real-time, streaming event notification with generative artificial intelligence enriched insights. In various embodiments, events are stored and enriched based on user sessions. While traditional user sessions are defined as interactions that happen within a specific time frame, systems and methods described herein can provide dynamically provisioned event queues related to the user's sessions that can be personalized and reacted to in real-time.

The real-time even notifications systems described herein can manage how, when, why and what notifications are delivered to various customer applications. The systems can provide users with customizable filtering options to reduce or summarize notifications, that are easy to understand and apply. By aggregating and safely storing events generated from disparate back-end applications or programs in a central repository, those events can be reviewed, summarized, augmented, filtered, and otherwise organized or modified to be streamed out to a remote user through a persistent, secure connection.

From a developer standpoint, the systems and methods described herein provide a consistent developer experience for the purpose of ensuring reusable, reliable, performant and secure implementation. The systems and methods herein can maintain user session connections and private data channels while persisting events for replays and analysis. In various embodiments, users can poll to ask questions about public and personalized events, or receive AI generated summaries and insights based upon these events.

In some instances, the management, augmentation, and delivery of event notifications can be used to incentivize or shape user behavior. Proactive behavior predication based on historical user actions combined with real-time data delivery may be used to change a user's focus and redirect behavior. In a financial services model, for example, a budgeting customer who is looking at investments may be redirected or otherwise encouraged to focus on controlling spending.

In various embodiments, server-sent events (SSE) server push notification technology may be used to enable the immediate notification of backend system events to web and mobile users. As noted, those events can be collected and securely stored from various backend systems and, in some instances, filtered, augmented, audited, and personalized. Exemplary uses can include real-time market updates to relevant shareholders, user insight changes, user profile updates & changes.

In various embodiments, automated AI-based cognitive engines or a set of agents and models can perform one or more of: monitoring customer or user activity, forming potential recommendations, and ultimately deciding what and when to inform the customer about in consistent and well-formed messages.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary pipeline for a cognitive real-time event notification system.

FIG. 2 shows an exemplary data flow for agentic artificial intelligence in a cognitive real-time event notification system.

FIG. 3 shows an exemplary internal data flow for an artificial intelligence event enrichment system.

FIG. 4 shows an exemplary use case for artificial intelligence driven decision and generation in a cognitive real-time event notification system.

FIG. 5 depicts exemplary architecture for a server sent events (SSE)-based persistence service for delivering event notifications according to certain embodiments.

FIG. 6 shows console snapshots of the Kafka Proxy/Emulator and Json Transformer servers on startup for an example real time event notification system according to various embodiments.

FIG. 7 shows a console snapshot of UI startup for an example real time event notification system according to various embodiments.

FIG. 8 shows a console snapshot of the UI after the “more input” button is pressed for an example real time event notification system according to various embodiments.

FIG. 9 shows a console snapshot of the Kafka Proxy/Emulator receiving the new messages in the PayPal Txn and Visa Txn topics for an example real time event notification system according to various embodiments.

FIG. 10 shows a console snapshot of the Json Transformer server when the new messages in the PayPal Txn and Visa Txn topics is received for an example real time event notification system according to various embodiments.

FIG. 11 shows a console snapshot of the UI during sample input processing for an example real time event notification system according to various embodiments.

FIG. 12 shows a console snapshot of the event consumption loop being run for an example real time event notification system according to various embodiments.

FIG. 13 shows console snapshots of the Kafka Proxy/Emulator and Json Transformer servers consuming, transforming, and producing messages between topics according to the workflow rules for an example real time event notification system according to various embodiments.

FIG. 14 shows a console snapshot of the UI with the button toggled back to “Stopped” after all messages have been processed in an example real time event notification system according to various embodiments.

### DETAILED DESCRIPTION

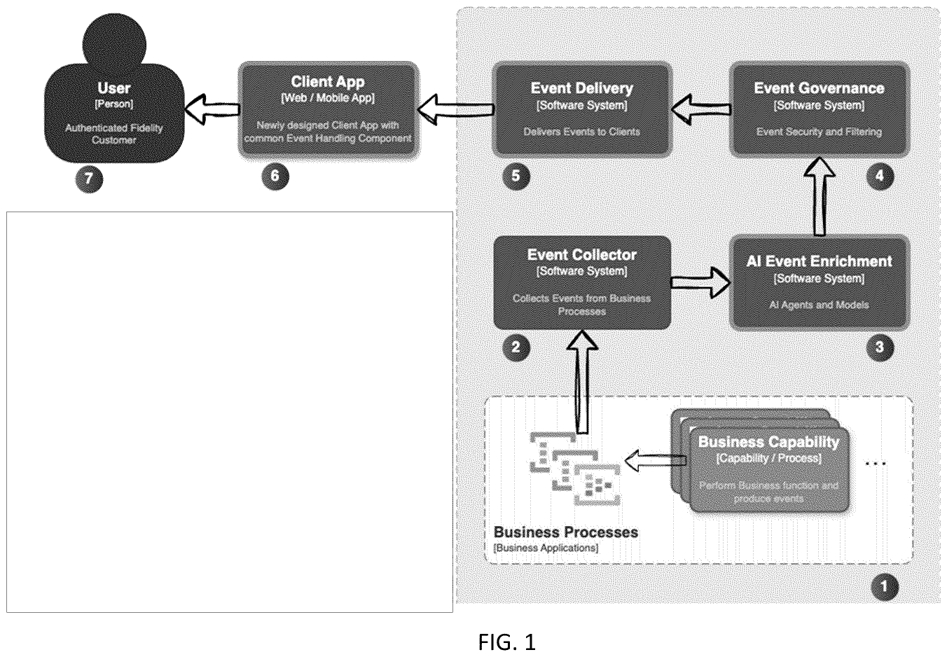

FIG. 1 illustrates an exemplary pipeline for a cognitive real-time event notification system according to certain embodiments. Block 1 represents back-end modules, software, programs, processes, or applications that may generate events. Systems and methods of the invention can be integrated into existing data structures to collect events already being generated by the organization's various applications. An event collector application or program (block 2) can collect these events, even from disparate applications that may not be in communication directly with each other. Block 3 represents event enrichment which can be performed by an agentic or agent-driven AI service. The enrichment can comprise cognitive actions such as dropping, deriving, aggregating, or otherwise enriching. The enriched events can then pass to an event governance, security, and/or filter service (block 4) to determine which enriched events should be delivered to which users in which circumstances.

The approved events can then be delivered using an event delivery application (block 5). This application or software system can maintain stateful enriched user events, providing a single point for event delivery across multiple event creating applications and allowing the server to keep track of the state of each user session such that information about the user's interactions and past requests can be maintained and used to inform event enrichment and delivery. The events can be received by a client application (block 6) on the user's client computing device (e.g., a mobile device or computer). The client application can interface with the event delivery system using common components for web and mobile. The user (block 7) can then receive and review the enriched event notifications. Security features can include user authentication and authorization through the client application before accessing notifications, thereby preventing disclosure of sensitive information. In various embodiments, the business processes or capabilities may create events or acquire events from external sources. AI Event Enrichment is described further in the 3^{rd} diagram.

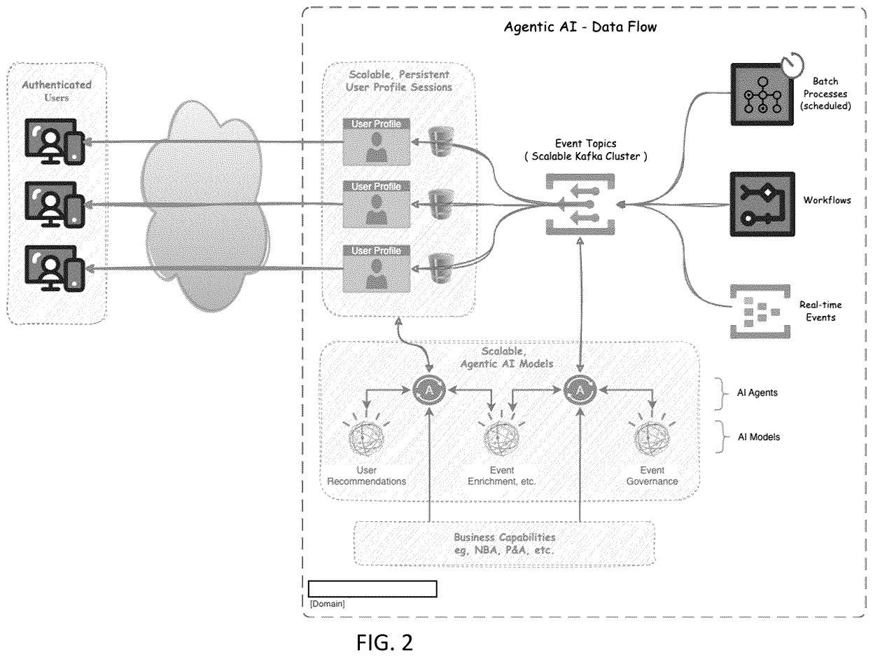

FIG. 2 shows an exemplary data flow for agentic artificial intelligence in a cognitive real-time event notification system. This diagram depicts solution characteristics including provisions for scalability and private user sessions for private data channels of notifications. Authenticated users can access the domain over the cloud, supported by individual user profiles and persistent sessions in a scalable manner. The agentic AI Models component is itself scalable and can use special purpose agents and models for recommendations, enrichment and governance. Event topics (or channels) are also scalable via, for example, Kafka Clusters.

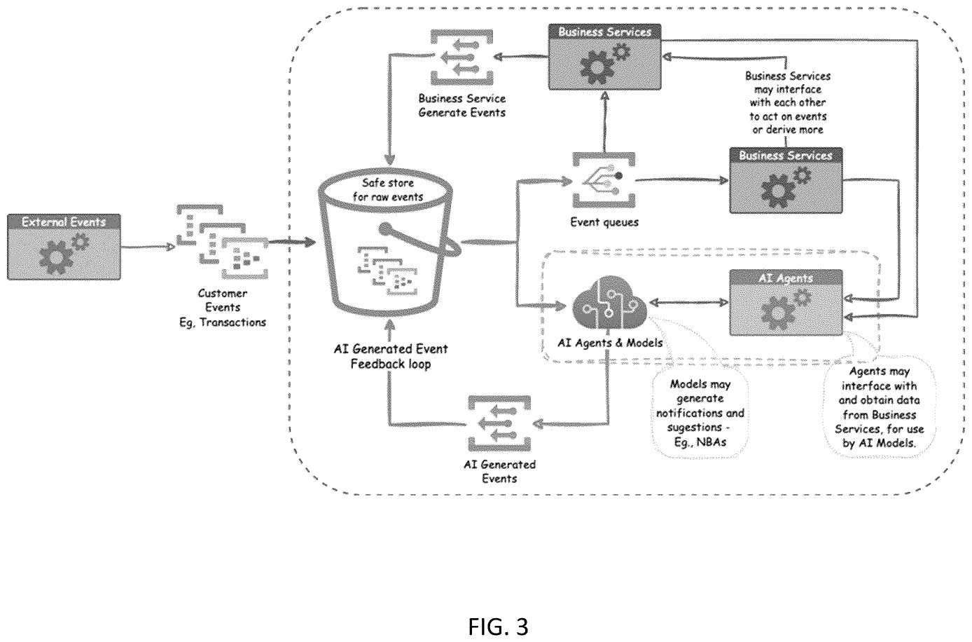

FIG. 3 shows an exemplary internal data flow for an artificial intelligence event enrichment system. As external events come into the system, they are initially and safely stored as raw events in an event repository, depicted in FIG. 3 as a bucket. These events can be forwarded or generated by various existing programs and business services, user initiated (e.g., a customer transaction), or may be generated by the AI agents and models. Regardless of source, the raw events can all be stored in the repository.

Raw events such as a customer transaction can be consumed by both Business services and AI Agents & Models. The various Business Services may further interface with each other by, for example, internal APIs to act on events or generate or derive additional events.

AI Agents & Models can act on raw events and interface with Business Services and/or generate new events via a feedback loop into the raw event bucket. AI Models may generate notifications and suggestions, such as Next Best Actions (NBAs). AI Agents may interface with and obtain data from Business Services, for use by the AI models, which can result in newly generated events that can be fed into the depicted feedback loop. Both Business Services and AI Agents & Models may generate new events and place them into the raw event bucket.

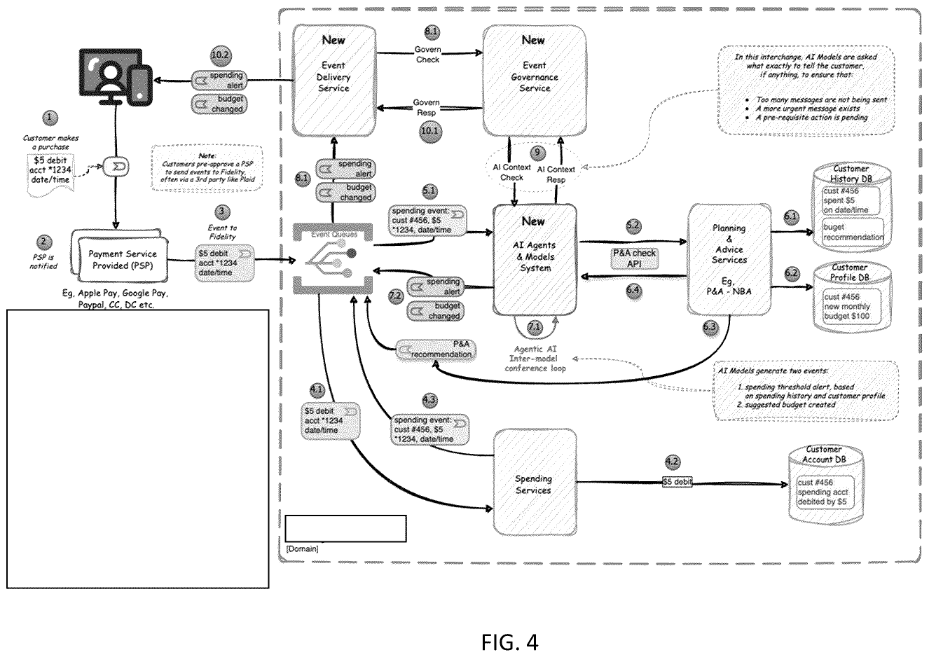

FIG. 4 shows an exemplary use case for artificial intelligence driven decision and generation in a cognitive real-time event notification system. The depicted use case involves a financial services embodiment for event notification resulting from a customer purchase. While the depicted scenario is for an individual customer, systems and methods of the invention can also apply to parents or guardians receiving spending alerts, suggested budgets, or other relevant event-driven notifications for teenagers, minors, or other dependents in need of supervision. Such third-party notifications can be made with the consent and/or awareness of all parties.

As shown in FIG. 4, a customer makes a new purchase as step 1. A payment service provider (PSP) such as apple pay, google pay, paypal, or venmo is notified at step 2 and generates an event that is forwarded (step 3) to the financial services provider domain and placed in an event queue.

One back-end business process, spending services, receives the event from the event queue (step 4.1), debits the customer's spending account (step 4.2), and publishes its own spending event to the event queue (step 4.3). Additionally, the original event is received (step 5.1) from the event queue by an AI agents and models service (discussed above). The AI agents and models system can perform a planning and advice check (step 5.2) by communicating the customer spend with an existing planning and advice business service application. That application can check spending history for the customer (step 6.1), make a budget proposal (step 6.2), and create its own planning and advice recommendation event that is returned to the event queue (step 6.3) and the AI agents and models system (step 6.4).

The AI agents and models system may include a spending and budget model that may confer with each other (step 7.1) via agents and may decide, cognitively, to accept the planning and advice recommendation and, in turn, generate additional events (e.g., a spending alert and a budget change event; step 7.2) that may be returned to the event queue.

An event delivery service receives the newly generated events (step 8.1) created by the AI agents and models system from the event queue and calls the event governance service (step 8.2). The Event governance service can then consult with the AI agents and models system to cognitively determine what, if anything, to tell the customer regarding the generated events (step 9). The AI agents and models system can make its determination to ensure that too many messages are not being sent, there is not a pre-requisite action pending, a more urgent message isn't pending, or other factors to streamline and enrich the event notification process. The AI agents and models can also further modify, substitute, or block the messages or notifications to achieve the desired goals.

The event governance service, after consultation with the AI agents and models system can then return a response to the event delivery service (step 10.1) dictating which, if any, notification are to be delivered to the user. Assuming both the spending alert and the budget notification are approved, they can then be delivered by the event delivery service to the user (step 10.2) via, for example, a push notification on their mobile device.

The AI agents and models system can comprise a set of human like experts, in the form of an automated AI based cognitive engine or set of agents and models; that together monitor customer activity, form potential recommendations and ultimately decide what and when to inform the customer about in consistent and well-formed messages.

Exemplary cognitive roles for these engines, agents, and models can include: 1) informing and inquiring from an existing business service application such as a planning and advise services module (P&A) whether customer activity results in any follow-up actions or recommendations; 2) applying cognitive rules to determine whether the P&A response should result in new internal events in the form of a feedback loop; and 3) governing customer messaging and deciding what message if anything should be sent to the customer.

Referring further to the exemplary use case depicted in FIG. 4, as customer spending transactions arrive from external payment service providers (PSPs), they are simply turned into internal events for processing by the systems. Spending Services can ingest raw transactions, perform verification and quality checks and turn them into internal spending events for the cognitive engine to consume. Everything can be event driven from this point forward.

The cognitive engine can then act on internal events as directed by pre-trained AI models which utilize AI agents that call internal APIs to get or share data. Following the depicted use case, it acts on the internal spending event by making a call to the P&A spending check API both to notify the P&A service and to see if any subsequent actions or recommendations are returned. For instance, in a next best action, the event carrying a payment amount ($5) is passed along with the user profile. The user profile is processed within the next best action service to determine what steps are completed in financial planning and then selects the recommendation for actions or a priority list. This result is then returned back to the broader system as an internal event that now carries a context-selected, enriched property that is supplied to the AI model. AI models can then determine whether further events should be created in a feed-back loop manner. Following the use case again, two events are generated and returned: a) spending alert & b) budget changed.

The event delivery service then acts on the spending alert and budget changed events. Before it delivers corresponding notifications to customers it first checks with the Event Governance Service, which in turn checks with the AI Agents and Models system to find out whether to send something to the customer. The AI models may alter or newly generate the message, if any, to be sent to the customer. In various embodiments, both the raw and enriched events can be stored in immutable event queues.

In certain embodiments, systems and methods herein can be used to generate dynamic topics that are used to prevent alert fatigue and tailor information relevant to the user as a means to ensure targeted, useful information is shared as opposed to over-alerting with raw information. Each event can contain both raw transactional/operational information as well as an AI-enriched insight combined and saved as a logical data object. Both the raw event and the enriched event can be used by further down-stream systems. In some embodiments, the AI-enriched event can in-turn be used to identify future subscription topics.

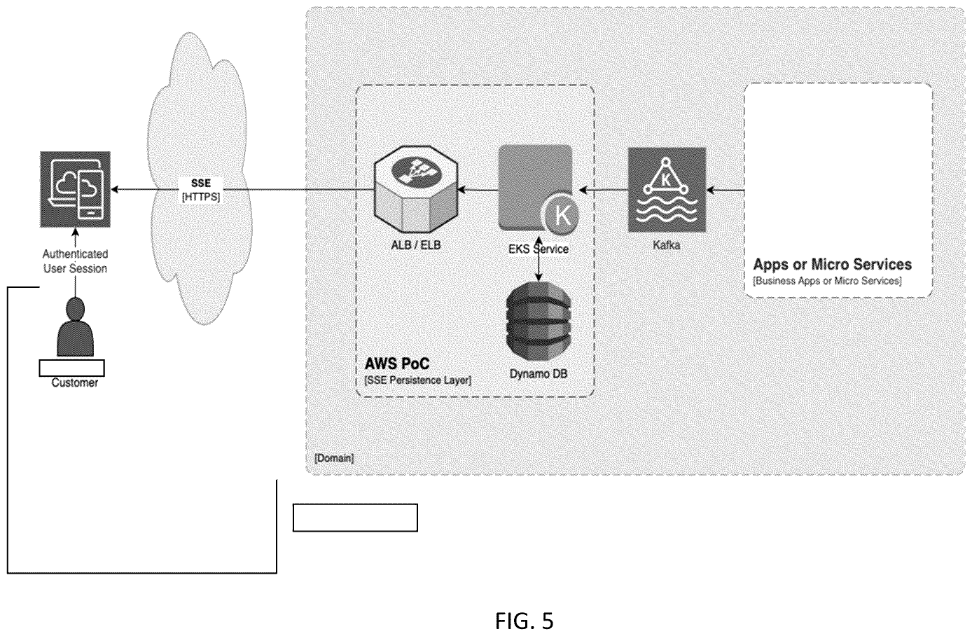

FIG. 5 depicts exemplary architecture for a server sent events (SSE)-based persistence service for delivering event notifications according to certain embodiments. As shown, security features can include that a user is logged in and authenticated to a user session on their client computing device. As shown, an SSE system is used to push notifications to the user. The SSE technology allows a client to receive automatic updates from a server via an HTTP connection and describes how servers can initiate data transmission towards clients once an initial client connection has been established. This connection can be stateful and persistent such that the server can keep track of the state of the user session, and maintain information about the user's interactions and past requests. While SSE is depicted, in various embodiments, polling, websockets, or other methods may be used for notification delivery. The SSE can use HTTPS for security and firewall concerns. An SSE persistence layer within the notification provider domain can use, for example, Amazon Web Services'(AWS) Elastic Kubernetes Service (EKS) to persist user sessions and event delivery status to maintain the stateful connection. An event store and stream-processing platform such as Apache Kafka may act as the message broker to take notifications from the various back-end applications or AI enrichment systems discussed above and forward them for delivery through the SSE-based persistence service.

The client computing devices, referred to above, can connect to one or more communications networks (e.g., network) in order to communicate with a server computing device to provide input and receive output relating to event notifications.

Exemplary client computing devices include but are not limited to server computing devices, desktop computers, laptop computers, tablets, mobile devices, smartphones, and the like. Typically, the client computing device includes a display device (not shown) that is embedded in and/or coupled to the client computing device for the purpose of displaying information to a user of the device. It should be appreciated that other types of computing devices that are capable of connecting to the components of the system can be used without departing from the scope of invention. It should be appreciated that the system can include any number of client computing devices.

In some embodiments, the client computing device can execute one or more software applications that are used in conjunction with applications or modules on the server computing device. For example, the client computing device can be configured to execute one or more native applications and/or one or more browser applications. Generally, a native application is a software application (in some cases, called an ‘app’) that is installed locally on the client computing device and written with programmatic code designed to interact with an operating system that is native to the client computing device. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device to perform functions (e.g., authenticate a user and receive and display event notifications). Generally, a browser application comprises software executing on a processor of the client computing device that enables the client computing device to communicate via HTTP or HTTPS with remote servers addressable with URLs (e.g., server computing device) to receive website-related content, including one or more webpages, for rendering in the browser application and presentation on the display device coupled to the client computing device. Exemplary mobile browser application software includes, but is not limited to, Firefox™, Chrome™, Safari™, and other similar software. The one or more webpages can comprise visual and audio content for display to and interaction with a user.

The communications network enables the client computing device to communicate with the server computing device and any databases storing information related to the delivery of event notifications. The network is typically comprised of one or more wide area networks, such as the Internet and/or a cellular network, and/or local area networks. In some embodiments, the network is comprised of several discrete networks and/or sub-networks (e.g., cellular to Internet).

The server computing device is a device including specialized hardware and/or software modules that execute on a processor and interact with memory modules of the server computing device, to receive data from other components of the system, transmit data to other components of the system, and perform functions (e.g., the event collection, processing, enrichment, and delivery steps discussed above). The server computing device may include any number of other programs that may execute on the processor of the server computing device and may each, despite being disparate programs, rely on a regular exchange of data between them and/or the database. In some embodiments, the various modules, programs, or applications are specialized sets of computer software instructions programmed onto one or more dedicated processors in the server computing device and can include specifically designated memory locations and/or registers for executing the specialized computer software instructions.

In some embodiments the functionality of the applications and modules can be distributed among a plurality of server computing devices. It should be appreciated that any number of computing devices, arranged in a variety of architectures, resources, and configurations (e.g., cluster computing, virtual computing, cloud computing) can be used without departing from the scope of the invention. The exemplary functionality of the applications, programs, and/or modules is described in detail throughout this specification.

If required databases for storing user and/or notification information may include a computing device (or in some embodiments, a set of computing devices) coupled to the server computing device and configured to receive, generate, and store specific segments of data relating events, users, and notifications. In some embodiments, all or a portion of the database can be integrated with the server computing device or be located on a separate computing device or devices. The database can comprise one or more databases configured to store portions of data used by the other components of the system, as will be described in greater detail below.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

Examples: Example 1—real time event notification demo console snapshots

An example of a real time event notification system according to certain embodiments is shown through snapshots of three consoles running the system. There are two backend servers: 1) a Kafka Proxy/Emulator, and 2) a Json Transformer as well as a UI console captured separately. AI Model calls appear in the UI console and are pointed out.

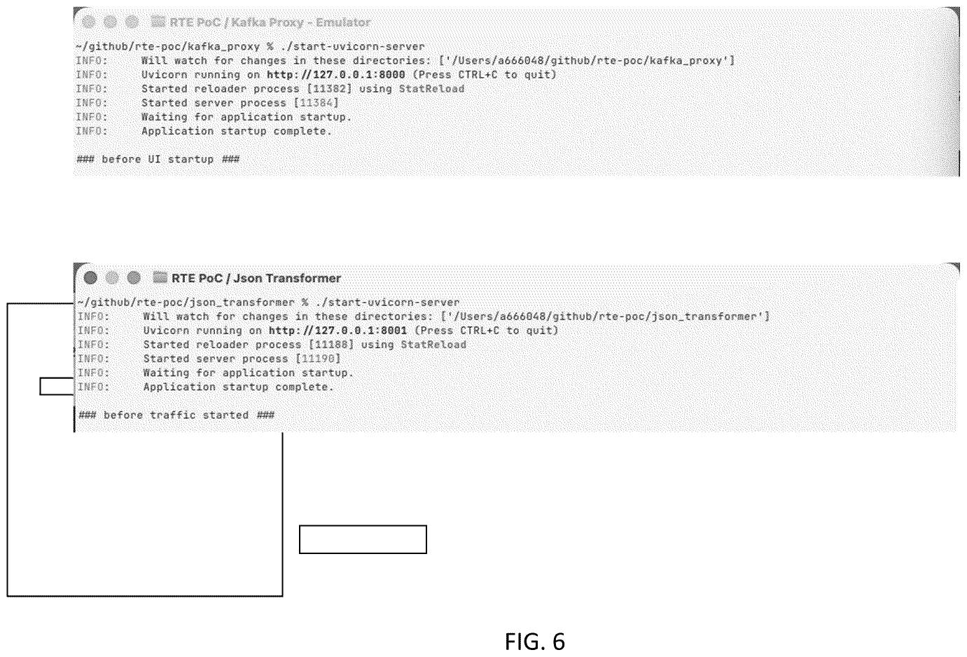

Step 1: Start Kafka Proxy/Emulator and Json Transformer servers—before starting UI. These are Python Uvicorn. org web or API servers which automatically restart if/when application code changes. FastAPI is used as it works well for integrating with APIs called from Streamlit—all in a modern pythonic, production-capable manner. FIG. 6 shows console snapshots of the Kafka Proxy/Emulator and Json Transformer servers on startup.

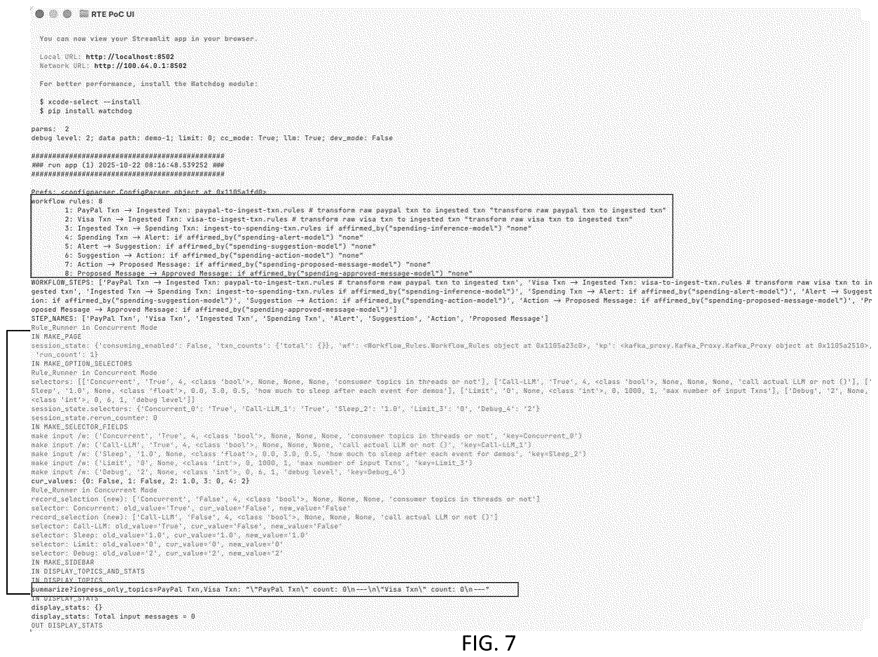

Step 2: Start the UI. FIG. 7 shows a console snapshot of the UI startup.
a. This is a Python Streamlit.io web app which, like with the Uvicorn.org API servers, automatically restarts if/when application code changes.
b. Workflow rule files are discovered within a given directory, read in and ingested into runtime objects.
c. Runtime preferences read in and set: Concurrent=False, Call-LLM=False, Sleep=1, Limit=0, Debug=2
   i. LLMs, or AI Models, are not yet fully developed.
   ii. The Call-LLM=False setting results in True affirmations for sake of demonstration.
d. Kafka topics created, as identified in the workflow rules:
   i. PayPal Txn, Visa Txn, Ingested Txn, Spending Txn, Alert, Suggestion, Action, Proposed Message.
e. The first two (PayPal Txn, Visa Txn) are determined to be ingress-only because none of the rules create them.
   i. For demo mode this means that new input is looked up for them when the “More Input” button is pressed.
   ii. For non-demo, or production mode, it can mean that external input is only allowable for them.

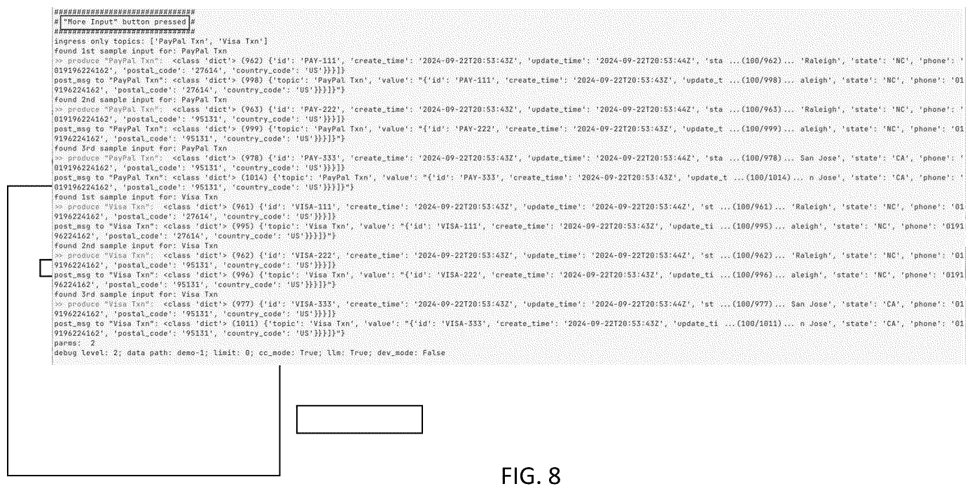

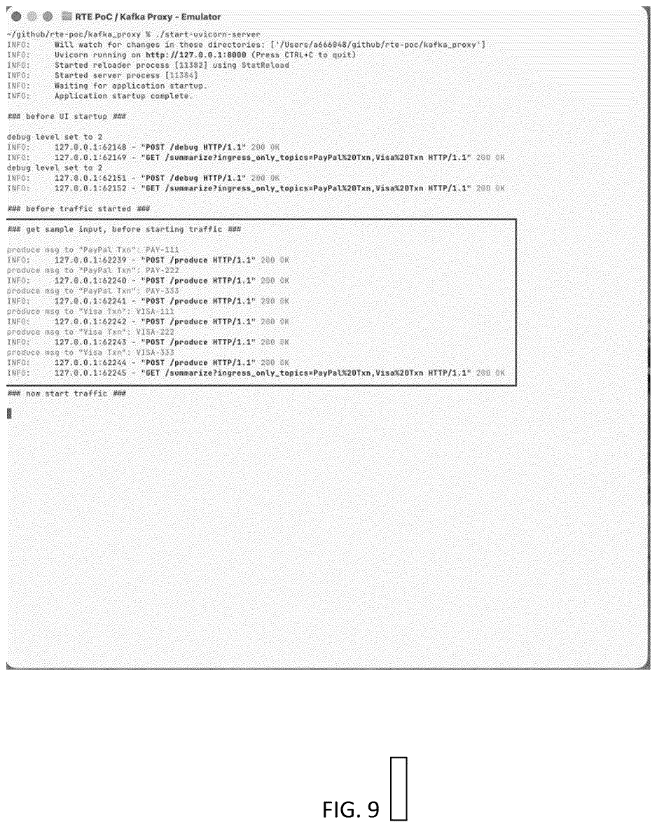

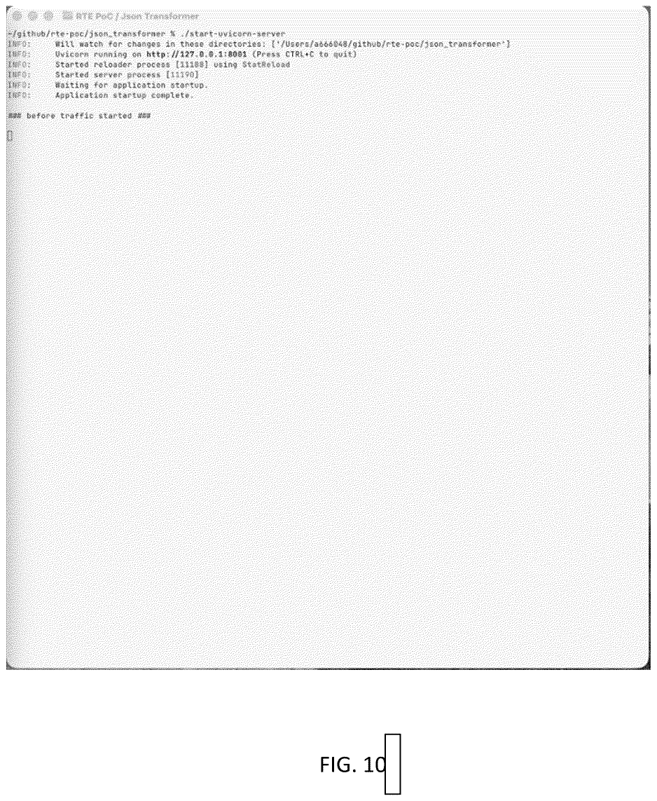

Step 3:“More Input” button pressed on the UI. FIG. 8 shows a console snapshot of the UI after the “more input” button is pressed where sample input is read for the Ingress-Only topics and sent, or produced as messages into Kafka. FIG. 9 shows a console snapshot of the Kafka Proxy/Emulator receiving the new messages in the PayPal Txn and Visa Txn topics. FIG. shows a console snapshot of the Json Transformer server when the new messages in the PayPal Txn and Visa Txn topics is received where the Json Transformations have not yet been performed as traffic has not been started.

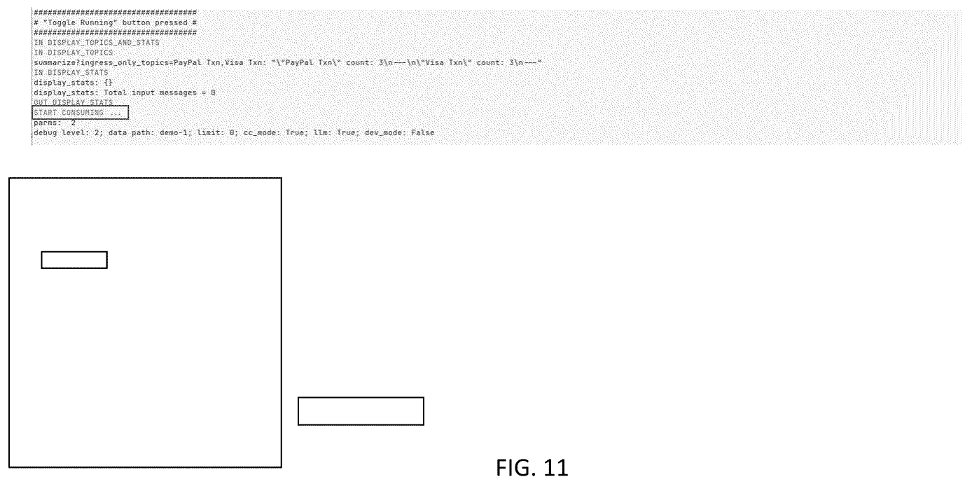

Step 4: Process all sample input. The “Stopped” button on the UI is pressed causing it to toggle to “Running”. The system then lets all traffic run and performs transformations and AI based affirmation checks according to workflow rules. The “Running” button on the UI is then pressed, causing it to toggle back to “Stopped”. FIG. 11 shows a console snapshot of the UI during sample input processing with the Running/Stopped button toggled.

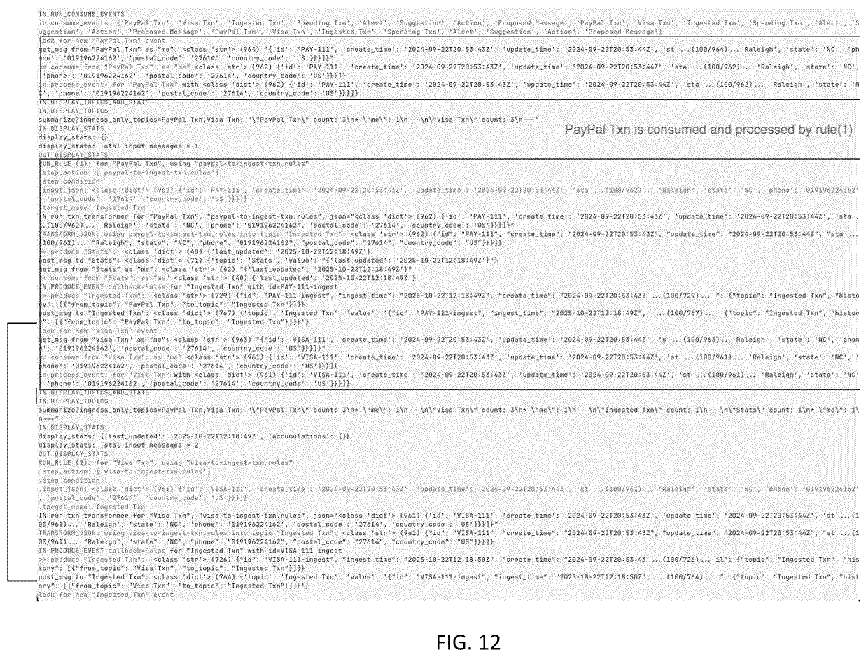

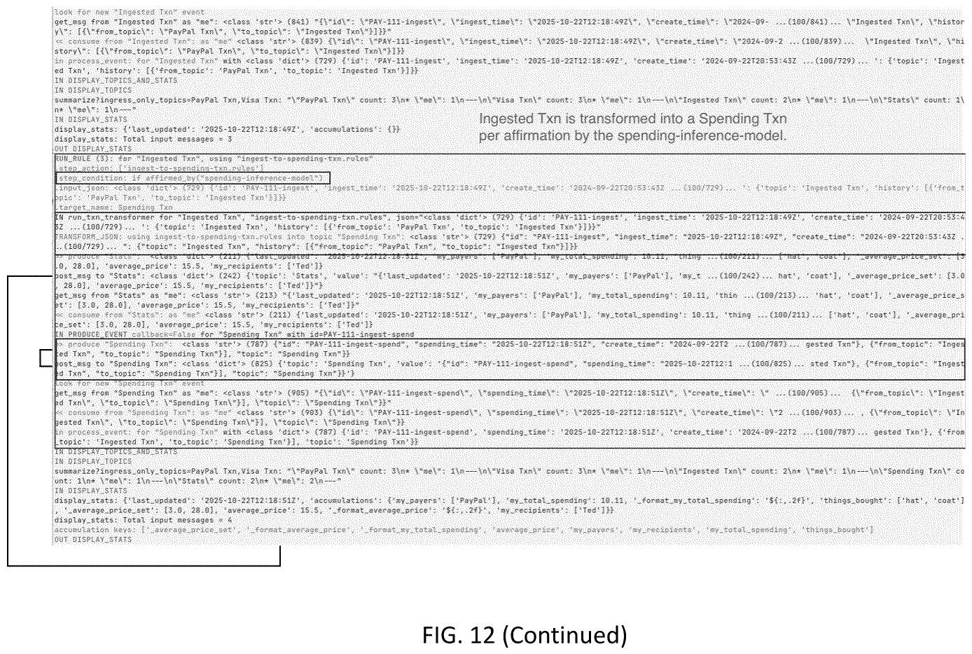

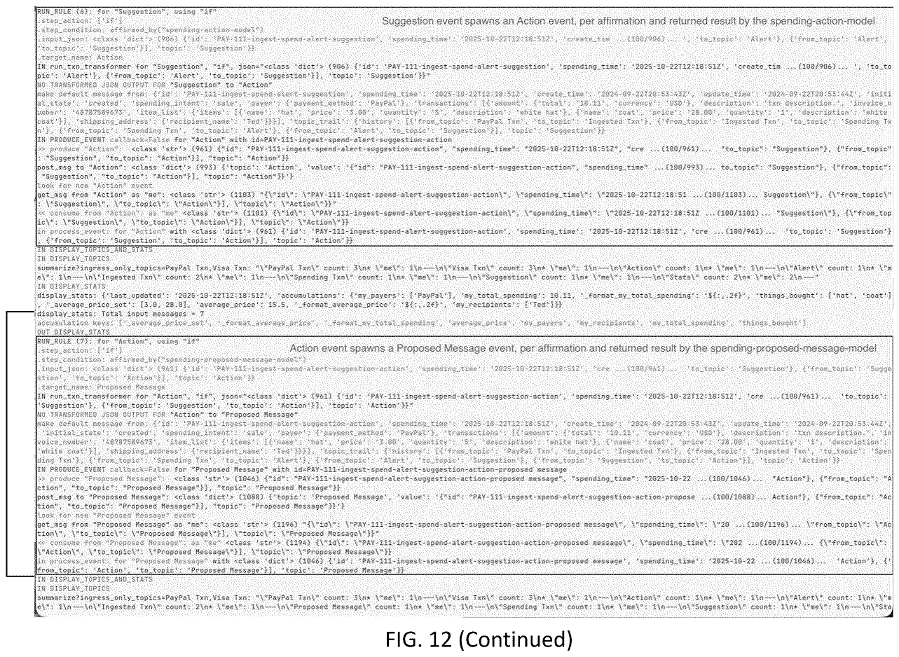

FIG. 12 shows a console snapshot of the event consumption loop being run. A PayPal transaction is consumed and processed by rule(1). The ingested PayPal transaction (according to the rules) is transformed into a Spending transaction as affirmed by the spending-inference-model. A suggestion event spawns an Action event, per affirmation and returned result by the spending-action-model. The action event then spawns a proposed message event, per affirmation and returned result by the spending-proposed-message-model.

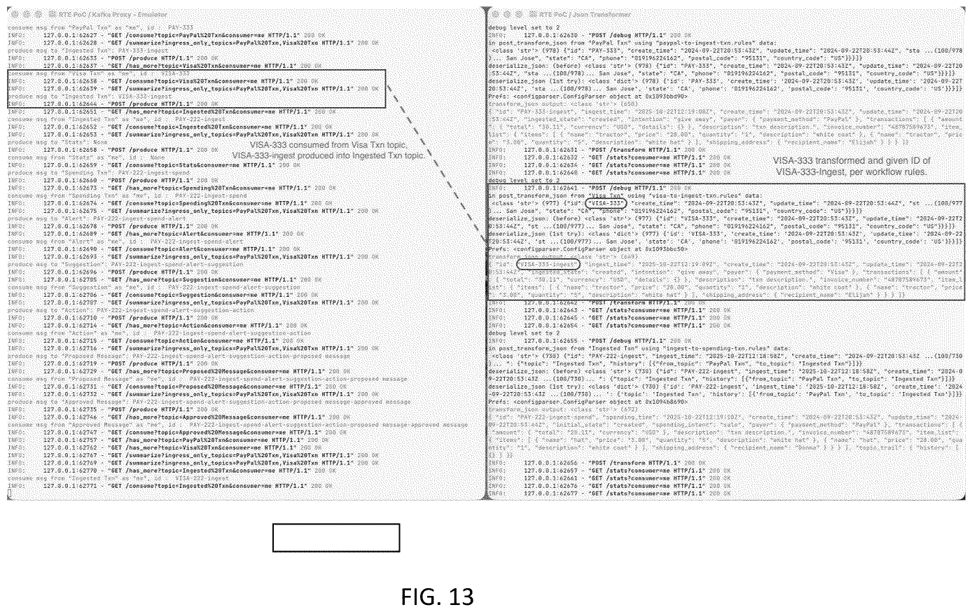

Step 5: The Kafka Proxy/Emulator and Json Transformer servers consume, transform and produce messages between topics according to the workflow rules a shown in FIG. 13.

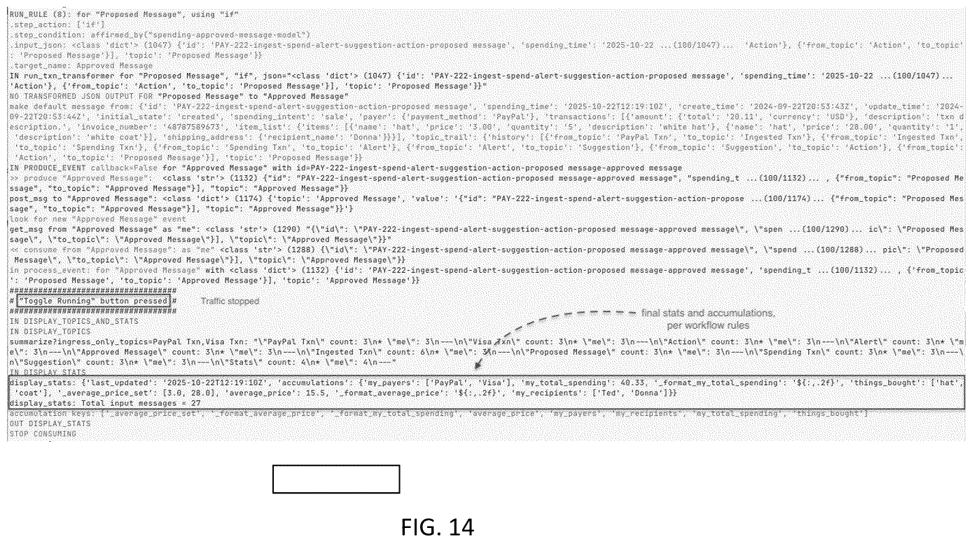

Step 6: The button is toggled back to “Stopped” after all messages have been processed as shown on the console snapshot of the UI in FIG. 14.

What is claimed is:

1. A computerized method for event-driven notifications, the method comprising:
receiving an event related to a user at an event collector;
processing the event using one or more artificial intelligence (AI) agents, wherein processing comprises one or more of:
obtaining additional data related to the event or the user from a database;
communicating with one or more internal business services to trigger the one or more internal business services to generate a new internal business services event based on the event or the additional data, and returning the new internal business services event to the event collector; or
generating a new agent event based on the event or the additional data, and returning the new agent event to the event collector;
comparing the event and any related new agent event or new internal business services event in the event collector to aggregate or enrich events using the one or more AI agents to create an event notification;
analyzing the event notification using an event governance service to confirm user authorization to receive the event notification;
delivering the analyzed event notification to the user via a computing device.

2. The computerized method of claim 1, wherein the event governance service comprises an AI model having access to user information from a user database.

3. The computerized method of claim 2, wherein analyzing the event notification further comprises modifying the event notification with the event governance system to generate a rules compliant event notification.

4. The computerized method of claim 1, wherein aggregating and enriching the events comprises one or more of:
determining how many notifications have been sent to the user within a certain period of time;
reviewing user preferences or activity history;
assessing urgency of all events related to the user in the event collector;
summarizing all events related to the user in the event collector;
dropping one or more events related to the user in the event collector; and
checking for pre-requisite actions pending for each event related to the user in the event collector.

5. The computerized method of claim 1, wherein the event is received from the one or more internal business processes.

6. The computerized method of claim 1, wherein the event is received from an external service.

7. The computerized method of claim 1, wherein the new agent event comprises a next best action.

8. The computerized method of claim 1, wherein delivering the analyzed event notification is performed by an event delivery service maintaining a stateful user session with the computing device.

9. The computerized method of claim 8, wherein the delivered analyzed event notification is a server sent event through a persisting user session.

10. The computerized method of claim 6, wherein:
the external service is a payment service provider;
the event is a purchase made by the user;
the additional data comprises user account or budget information; and
the one or more internal business services comprise a financial planning service or a spending service and the new internal business services event comprises a financial planning recommendation or a spending event.

11. A computer system for event-driven notifications, the system comprising a computing device comprising a processor and a memory storing instructions that, when executed by the processor, cause the processor to perform the steps of:
receiving an event related to a user at an event collector;
processing the event using one or more artificial intelligence (AI) agents, wherein processing comprises one or more of:
obtaining additional data related to the event or the user from a database;
communicating with one or more internal business services to trigger the one or more internal business services to generate a new internal business services event based on the event or the additional data, and returning the new internal business services event to the event collector; or
generating a new agent event based on the event or the additional data, and returning the new agent event to the event collector;
comparing the event and any related new agent event or new internal business services event in the event collector to aggregate or enrich events using the one or more AI agents to create an event notification;
analyzing the event notification using an event governance service to confirm user authorization to receive the event notification;
delivering the analyzed event notification to the user via a computing device.

12. The computer system of claim 11, wherein the event governance service comprises an AI model having access to user information from a user database.

13. The computer system of claim 12, wherein analyzing the event notification further comprises modifying the event notification with the event governance system to generate a rules compliant event notification.

14. The computer system of claim 11, wherein aggregating and enriching the events comprises one or more of:
determining how many notifications have been sent to the user within a certain period of time;
reviewing user preferences or activity history;
assessing urgency of all events related to the user in the event collector;
summarizing all events related to the user in the event collector;
dropping one or more events related to the user in the event collector; and
checking for pre-requisite actions pending for each event related to the user in the event collector.

15. The computer system of claim 11, wherein the event is received from the one or more internal business processes.

16. The computer system of claim 11, wherein the event is received from an external service.

17. The computer system of claim 11, wherein the new agent event comprises a next best action.

18. The computer system of claim 11, wherein delivering the analyzed event notification is performed by an event delivery service maintaining a stateful user session with the computing device.

19. The computer system of claim 18, wherein the delivered analyzed event notification is a server sent event through a persisting user session.

20. The computer system of claim 16, wherein:
the external service is a payment service provider;
the event is a purchase made by the user;
the additional data comprises user account or budget information; and
the one or more internal business services comprise a financial planning service or a spending service and the new internal business services event comprises a financial planning recommendation or a spending event.
